(19) United States
(12) Patent Application Publication
(10) Pub. No.: US 2009/0129935 A1
(43) Pub. Date: May 21, 2009

(54) PUMP SUCTION PRESSURE LIMITING SPEED CONTROL AND RELATED PUMP DRIVER AND SPRINKLER SYSTEM

(76) Inventors: Kevin J. Kunkler, Cincinnati, OH (US); John T. Whitney, Blanchester, OH (US)

Correspondence Address: THOMPSON HINE L.L.P.;Intellectual Property Group, P.O. BOX 8801, DAYTON, OH, 45401-8801, US

(21) Appl. No.: 12/273,087

(22) Filed: Nov. 18, 2008

Related U.S. Application Data
(60) Provisional application No. 60/989,613, filed on Nov. 21, 2007.

(51) Int. Cl. A62C 35/00; F04B 49/00

(52) U.S. Cl. 417/1; 169/16; 417/53

(57) ABSTRACT

A building sprinkler system includes a pump that feeds a plurality of sprinkler heads. A driver is operatively connected to the pump for driving the pump. A speed control is responsive to suction pressure at a suction side of the pump. The speed control is configured to reduce driver speed when the suction pressure falls below a set threshold pressure value to maintain the suction pressure above the set threshold pressure value.

### CROSS-REFERENCE TO RELATED APPLICATIONS

This application claims priority to U.S. Provisional Application No. 60/989,613, filed Nov. 21, 2007, the details of which are hereby incorporated by reference as if fully set forth herein.

### TECHNICAL FIELD

This application relates to sprinkler systems and more particularly to a sprinkler system fire pump and fire pump driver with speed control.

### BACKGROUND

Building (or other facility) sprinkler systems provide pressurized liquid (e.g., water) to extinguish fire. A pump is used to provide the water pressure. The pump may be powered by an electric motor or other type of pump driver, such as an internal combustion engine.

Such sprinkler systems are often designed for a defined flow rate and pressure. For a given engine/pump combination, the discharge line pressure for the pump is dependent on the fluid flow rate through the system and the pressure of the water being supplied to the pump (also called suction pressure). The suction pressure may have a wide range between high and low pressures and will characteristically decrease with increased fluid flow rate. In some instances, there is a concern that if the suction pressure falls below atmospheric pressure, ground water can infiltrate the suction line which can contaminate the drinking water supply. Furthermore, low or negative suction pressure can lead to damage such as pipe collapse due to external forces acting on the pipe.

### SUMMARY

In an aspect, a building sprinkler system includes a pump that feeds a plurality of sprinkler heads. A driver is operatively connected to the pump for driving the pump. A speed control is responsive to suction pressure at a suction side of the pump. The speed control is configured to reduce driver speed when the suction pressure falls below a set threshold pressure value to maintain the suction pressure above the set threshold pressure value.

In another aspect, a method of controlling a pump driver of a building sprinkler system is provided. The method includes operating the pump driver connected to a pump thereby delivering fluid from a building fluid source. Speed of the pump driver is controlled based on pressure at a suction side of the pump.

In another aspect, a speed control system for controlling speed of a pump driver operatively connected to a pump of a building sprinkler system is provided. The speed control system includes a throttle for controlling pump driver speed. An actuator includes a throttle linkage connected to the throttle. The actuator is controlled in response to pressure at a suction side of the pump. The actuator is configured to move the throttle lever when the suction pressure falls below a set threshold pressure value.

Various advantages and features of the invention will be apparent from the following description of particular embodiments.

### BRIEF DESCRIPTION OF DRAWINGS

FIG. 1 is a partial, perspective view of an embodiment of a sprinkler system;

FIG. 2 is a diagrammatic, partial view of the sprinkler system of FIG. 1;

FIG. 3 illustrates an embodiment of a method of controlling the sprinkler system of FIG. 1;

FIG. 4 is a diagrammatic view of another embodiment of a sprinkler system;

FIG. 5 is a side, section view of an embodiment of a valve assembly for use in the sprinkler system of FIG. 4;

FIG. 6 is a side, section view of another embodiment of a valve assembly for use in the sprinkler system of FIG. 4;

FIG. 7 is diagrammatic, partial view of another embodiment of a sprinkler system; and

FIGS. 8 and 9 are illustrative, exemplary plots of system and pump performance curves.

### DETAILED DESCRIPTION

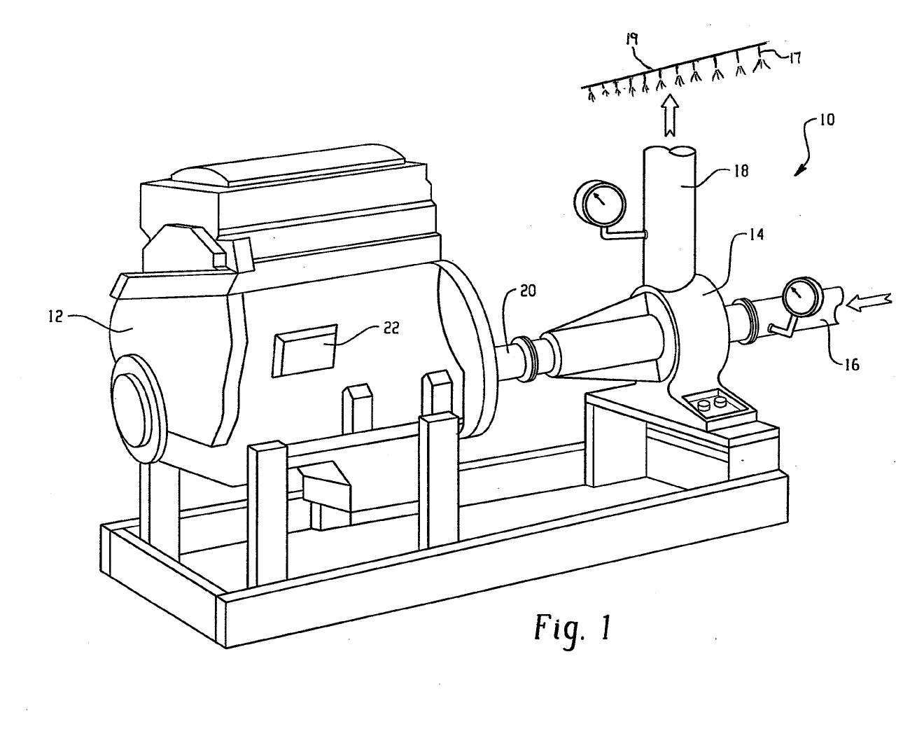

Referring to FIG. 1, a sprinkler system, generally referred to as element 10, includes an engine or motor, in this instance, an internal combustion engine 12 coupled to a pump 14. The pump 14 moves water from a pump inlet 16, through an outlet pipe 18 and to sprinkler heads 17 of a fluid delivery system 19. The pump 14 is operated by the internal combustion engine 12, which can be a diesel engine. The engine 12, however, could be another type of internal combustion engine or an electric motor. The engine 12 drives a shaft 20 that operates the pump 14. The RPM of the engine 12 and thereby shaft 20 is controlled by a throttle controller 22.

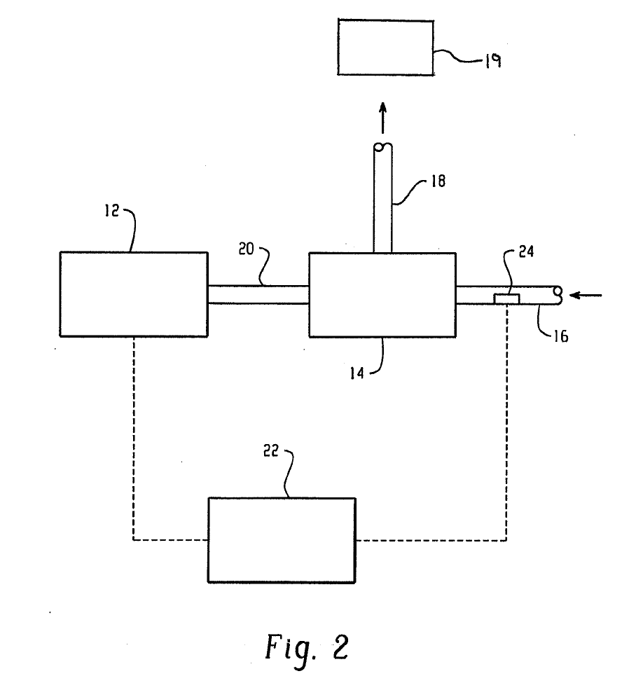

Referring to FIG. 2, a pressure sensor 24 is connected to the suction side of the pump 14. The pressure sensor 24 provides a signal that is indicative of suction pressure at the pump inlet 16. The throttle controller 22 receives the signal from the pressure sensor 24 and determines (e.g., using a processor and memory) whether the suction pressure is below a set value (e.g., selected from a pressure between about 5 psi and about 30 psi). In some embodiments, the set pressure value is selectable by an operator from a range of pressure values, for example, using a user input (e.g., a dial, keypad, button, etc.). In one embodiment, a second, lower set pressure value (e.g., at or below about 5 psi) may be used for determining if the engine 12 is to be shut down.

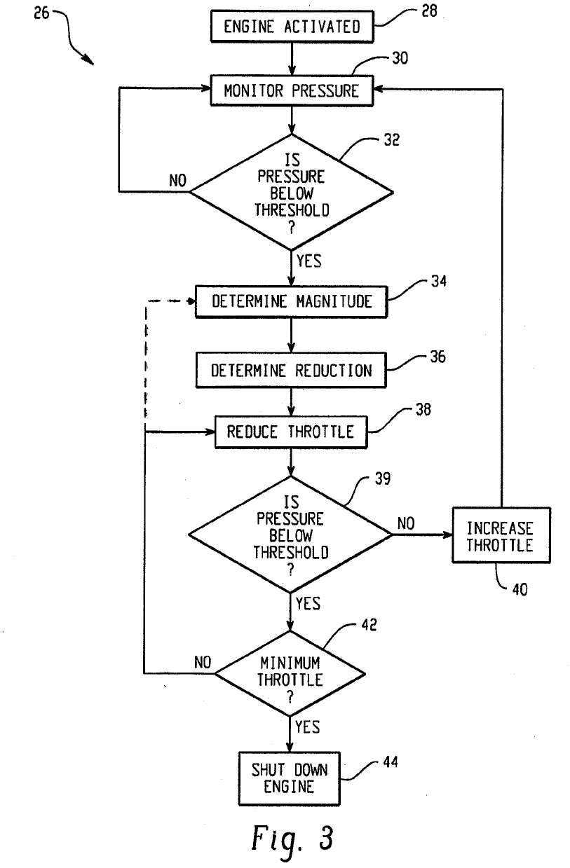

FIG. 3 illustrates a method 26 for controlling the engine 12 of the sprinkler system 10. At step 28, with the engine 12 already activated, liquid is pumped from the pump inlet 16, through the outlet pipe 18 and toward the sprinkler heads. At step 30, the pressure sensor 24 sends a signal indicative of pressure at the suction side of the pump 14. The throttle controller 22 determines whether the detected pressure is below the set pressure value at step 32 using the signal from the pressure sensor 24. If the detected pressure is determined to be above the set pressure value, then the throttle controller 22 does not command a reduction in engine speed. If the detected pressure is determined to be below the set pressure value, the throttle controller 22 determines the magnitude of the difference between the detected pressure and the set pressure value at step 34. At step 36, the throttle controller 22 determines a reduction in engine speed based on PID (proportional-integral-derivative) logic. The PID logic may include gain settings that determine the level of damping to reach the desired reduction in engine speed. The gain settings can also help control the time it takes to reach the desired reduction in engine speed and how much overshoot and oscillation around the throttle setting will occur.

At step 38, the throttle controller 22 reduces the throttle of the engine 12 thereby reducing the engine speed. The throttle controller 22 continues to monitor the signal from the pressure sensor 24. If the throttle controller 22 determines at step 39 that the pressure at the suction side of the pump 14 has increased above the set pressure value, the throttle controller 22 increases the speed of the engine 12, for example, back to its normal operating throttle at step 40. If the throttle controller 22 determines at step 39 that the pressure at the suction side of the pump 14 remains below the set pressure value, the throttle controller determines whether the engine throttle is at a minimum throttle at step 42. If the engine throttle is not at a minimum, the throttle controller 22 may again decrease the throttle of the engine 12 and monitor the signal from the pressure sensor 24. In some embodiments, represented by the dashed line, the method 26 may repeat steps 34 and 36. If the engine throttle is at a minimum throttle and the pressure at the suction side of the pump remains below the set pressure value, the throttle controller 22 shuts down the engine 12 at step 44 and signal to an alarm, for example, to alert an operator.

In some embodiments, the throttle controller 22 includes a deadband range that prevents continuous throttle setting changes, for example, due to relatively small pressure changes detected by the throttle controller 22 using the pressure sensor 24. Instead, the pressure detected at the suction side of the pump using the pressure sensor 24 will have to decrease below or above the deadband range before the throttle controller 22 will command a reduction or increase in the engine's throttle setting.

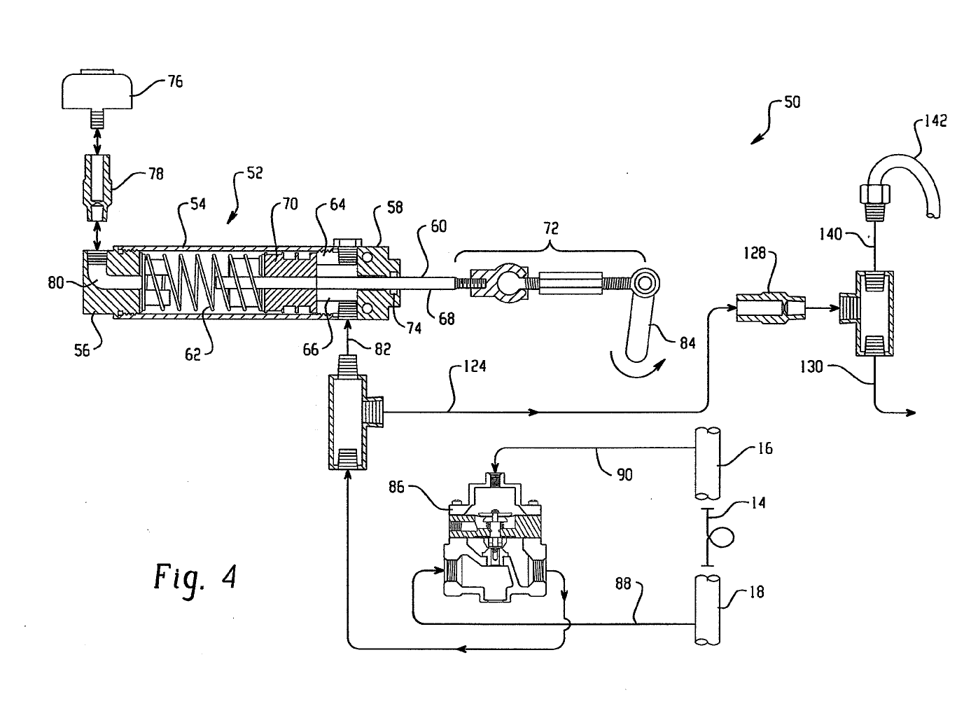

While the above discussion focuses on an electronic throttle control system, a mechanical throttle control system may be used. Referring to FIG. 4, a throttle control system 50 includes a throttle control actuator assembly 52 including a cylinder 54. An end block 56 closes and seals an end of the cylinder 54 and an end block 58 closes and seals an opposite end of the cylinder. A slidable piston 60 is received in the cylinder 54 and a compression spring 62 extends from end block 56 to the piston. The spring 62 biases the piston 60 against a shoulder 64 of end block 58, which corresponds to a full throttle position.

Within the end block 58 is a fluid receiving chamber 66. A piston rod 68, integral with a piston head 70 of the piston 60, extends axially through chamber 66 and beyond the end block 58. The piston rod 68 connects to a throttle linkage 72, the length of the throttle linkage being adjustable to facilitate proper setting of the full throttle position. The piston rod 68 may be sealed by an o-ring 74 thereby preventing fluid leakage past the piston rod.

A fluid dampening reservoir 76 is attached to the end block 56 via an orifice 78 thereby fluidly communicating with the cylinder 54 through fluid channel 80 within the end block 56. Orifice 78 is used to dampen fluid pressure surges that may otherwise be transmitted directly to the dampening reservoir 76.

Fluid pressure is received within the fluid receiving chamber 66, from fluid line 82, that acts upon the piston 60. This fluid pressure can cause movement of the piston 60 to compress the spring 62 thereby rotating a throttle lever 84 counterclockwise due to the linkage 72 thereby slowing the throttle of engine 12.

Fluid pressure to the fluid receiving chamber 66 is controlled, at least in part, by a valve assembly 86. The valve assembly 86 receives fluid pressure from the discharge side of the pump 14 through line 88 and fluid pressure from the suction side of the pump through line 90.

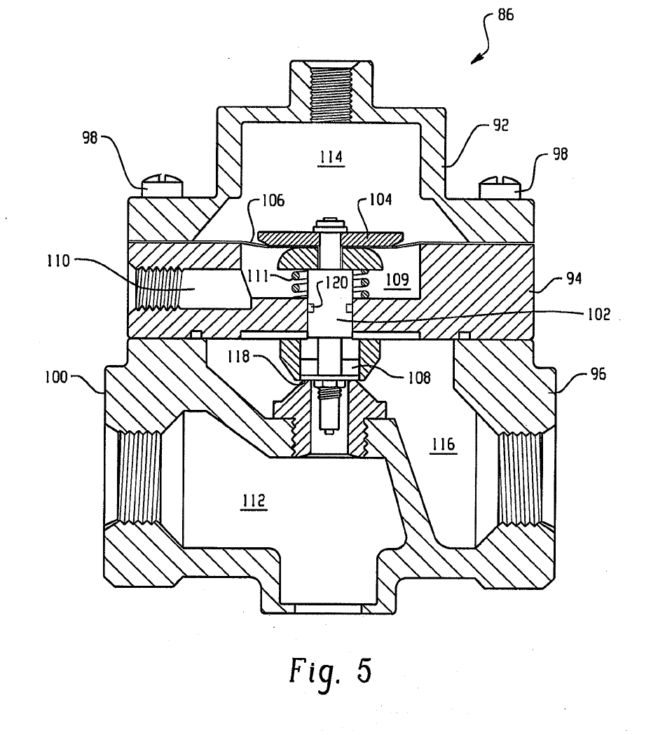

Referring now to FIG. 5, the valve assembly 86 includes an upper housing member 92, a mid housing member 94 and a lower housing member 96 that are fastened together by fasteners 98 to form a valve body 100. A valve stem 102 is located in the valve body 100 and is connected to an upper valve disc 104 that connects the valve stem to a flexible diaphragm 106 and a lower valve disc 108. The flexible diaphragm 106 spans a vented chamber 109 including vent 110 and is located between the upper and mid housing members 92 and 94 to provide a seal member therebetween. A compression spring 111 is used to apply a biasing force against the upper valve disc 104.

As noted above, the valve assembly 86 utilizes hydraulic pressure from the discharge and suction sides of the pump 14 to operate. A pump discharge chamber 112 is connected to the line 88 that receives fluid pressure from the discharge side of the pump 14. A suction supply chamber 114 is connected to the line 90 that receives fluid pressure from the suction side of the pump 14. A control circuit chamber 116 is connected to the fluid line 82 that leads to the fluid receiving chamber 66 of the throttle control actuator assembly 52.

During normal operation which is illustrated by FIG. 5, hydraulic pressure within the suction supply chamber 114 overcomes both the bias force applied by the spring 111 and an opposing force applied by hydraulic pressure within the pump discharge chamber 112 in order to seat the lower valve disc 108 against a sealing surface 118, which prevents flow of water into the control circuit chamber 116. The hydraulic pressure within the suction supply chamber 114 overcomes both the bias force applied by the spring 111 and the opposing force applied by hydraulic pressure within the pump discharge chamber 112 because an area of the diaphragm 106 exposed to the hydraulic pressure within the suction supply chamber 114 is much greater than an area of the lower valve disc 108 exposed to the hydraulic pressure within the pump discharge chamber 112. Thus, it takes a much lower hydraulic pressure within the suction supply chamber 114 to seat the lower valve disc 108 against the sealing surface 118 than it does for the hydraulic pressure within the pump discharge chamber 112 (in combination with the spring force) to unseat the lower valve disc from the sealing surface. A sealing member 120 (e.g., an o-ring) prevents pressurized fluid from moving past the valve stem 102.

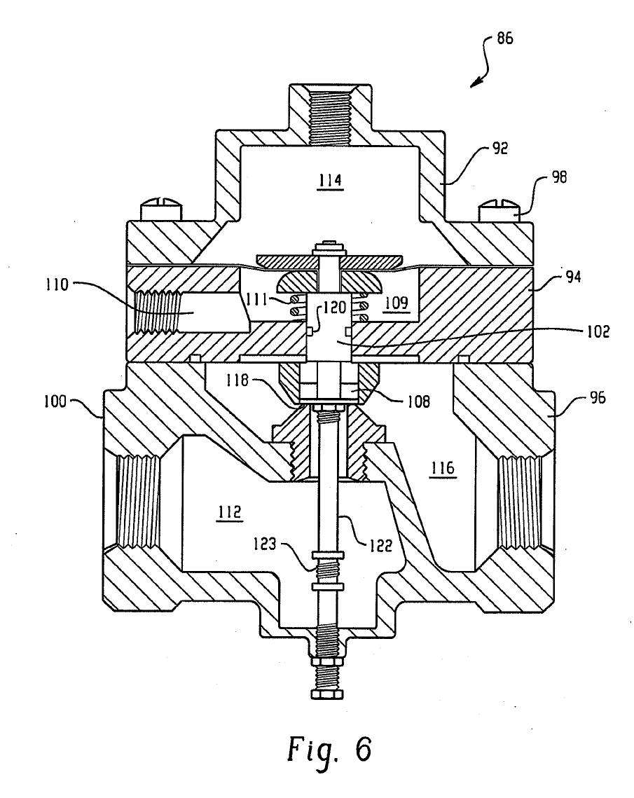

When the hydraulic pressure at the suction side of the pump 14 drops below a set value (e.g., a pressure between about 5 psi and 30 psi), the hydraulic pressure in the suction supply chamber 114 is no longer sufficient to seat the lower valve disc 108 against the sealing surface 118 and the hydraulic pressure in the pump discharge chamber 112 and the spring force unseat the lower valve disc thereby allowing pressurized fluid to flow from chamber 112 into the circuit control chamber 116. Referring briefly to FIG. 6, an adjustment device 122 may be used to adjust the bias force applied to unseat the lower valve disc 108 from the sealing surface 118. The adjustment device 122 includes a spring 123 that allows for adjustment of the set pressure value.

Referring back to FIG. 4, hydraulic pressure is received by the valve assembly 86 from both the pump discharge 18 (FIG. 1) through line 88 and the pump inlet 16 through line 90. The valve assembly 86 is normally closed during normal operating conditions as described above. If the pressure on the suction side of the pump 14 falls below the set pressure value, the valve assembly 86 opens thereby permitting fluid to flow through line 82, a control line 124, through orifice 128 and into a drain 130. As fluid flows into the orifice 128, a controlled back pressure is formed in control line 124 and in line 82 communicating with the fluid receiving chamber 66 in the throttle control actuator assembly 52. Thus the pressure acting upon the piston 60 is substantially reduced below the pump discharge pressure (which may be in the range of 110 to 240 psi, such as about 170 psi), but the pressure acting upon the piston varies as the pressure in the suction supply chamber 114 varies when the lower valve disc 108 unseats from the surface 118.

At start up and/or during normal steady state operating conditions, the throttle lever 84 and the throttle control actuator assembly 52 are positioned as illustrated in FIG. 4 with the compression spring 62 biasing the piston 60 toward its extended position. In this configuration, the throttle lever 84 is in its full throttle position whereby the pump 14 is providing a set water flow rate and working pressure at rated operating speed throughout the sprinkler system. As the system is operating, the pump discharge chamber 112 receives pressure from the pump discharge 18 and the suction supply chamber 114 receives pressure from the pump inlet 16. So long as the pressure within the pump inlet 16 is above the set pressure value (e.g., between about 5 and about 30 psi), the valve assembly 86 remains closed and the throttle lever position is unchanged.

In the event that the pressure at the suction side of the pump 14 goes below the set pressure value, the valve assembly 86 opens as described above thereby permitting fluid flow from chamber 112 to chamber 116 and subsequently into line 82. Fluid also flows into the control line 124, through orifice 128 and into drain 130. The orifice 128 acts to restrict fluid flow trough the control line 124 thereby causing a controlled back pressure throughout the control line and into the fluid receiving chamber 66 of the throttle control actuator assembly 52. As the pressure at the suction side of the pump 14 varies causing the lower valve disc 108 to move up and down, the back pressure caused by the orifice 128 also varies causing the piston 60 to extend and retract thereby retarding and advancing the throttle lever 84. Once the pressure at the suction side of the pump 14 rises above the set pressure value, the valve assembly 86 closes thereby preventing or reducing further fluid flow into line 82. Fluid flow through orifice 128 continues such that pressure within the control line 124 and line 82 decays to a pressure below that needed to overcome the bias provided by spring 62. The spring 62 then biases the piston 60 in its extended position with the throttle lever 84 in its normal operating position.

The fluid dampening reservoir 76 may be used to dampen rapid fluid pressure fluctuations that may occur between the valve assembly 86 and the fluid receiving chamber 66. System 50 can further include line 140 and hose 142 that can be used to dump pressure within the system.

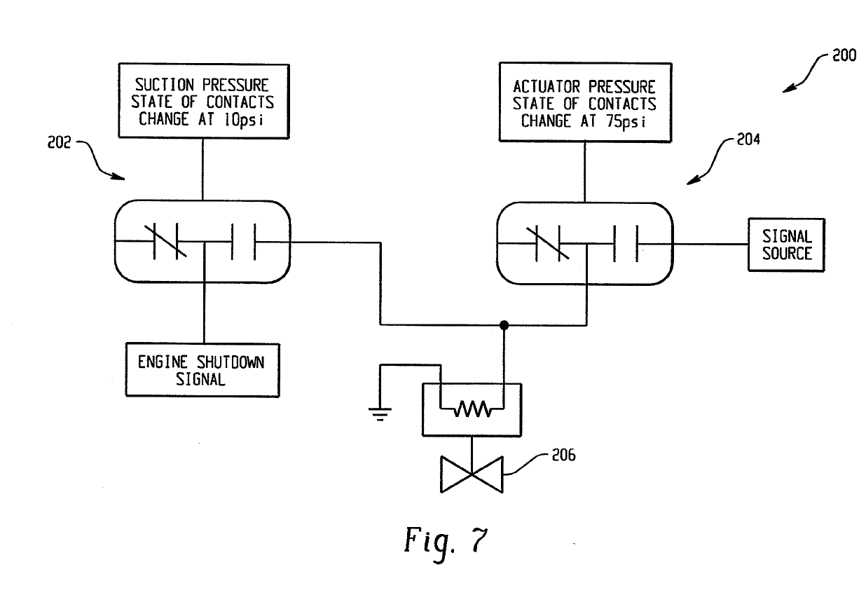

Referring to FIG. 7, throttle control system 200 includes a suction pressure sensor assembly 202 that monitors the suction pressure at pump inlet 16 and an actuator pressure sensor assembly 204 that monitors pressure in chamber 66 of the throttle control actuator assembly 52 (see FIG. 4). For example, the cylinder pressure sensor assembly 204 may include a pressure sensor located at any of the chamber 66, line 82 or line 124 of FIG. 4 for detecting pressure at the chamber 66. If the pressure detected by the actuator pressure sensor assembly 204 rises above a set pressure value (e.g., 75 psi) as the pump throttle is decreased and if pressure detected by the suction pressure sensor assembly 202 is below another set value (e.g., 10 psi), then an engine shut down signal is provided that causes the engine 12 to shut down. An exhaust valve 206 is provided to direct controlled backpressure to a drain (for example, drain 142 of FIG. 4).

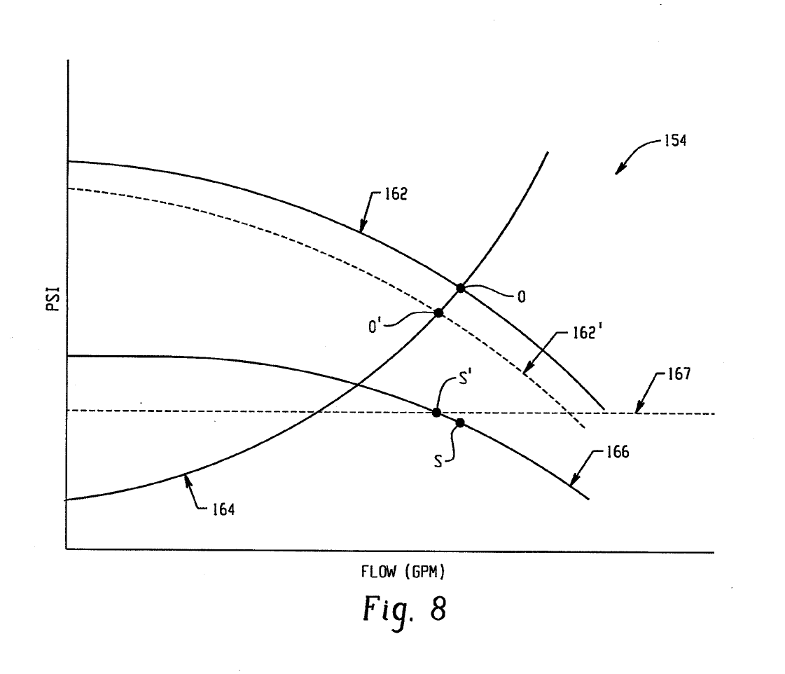

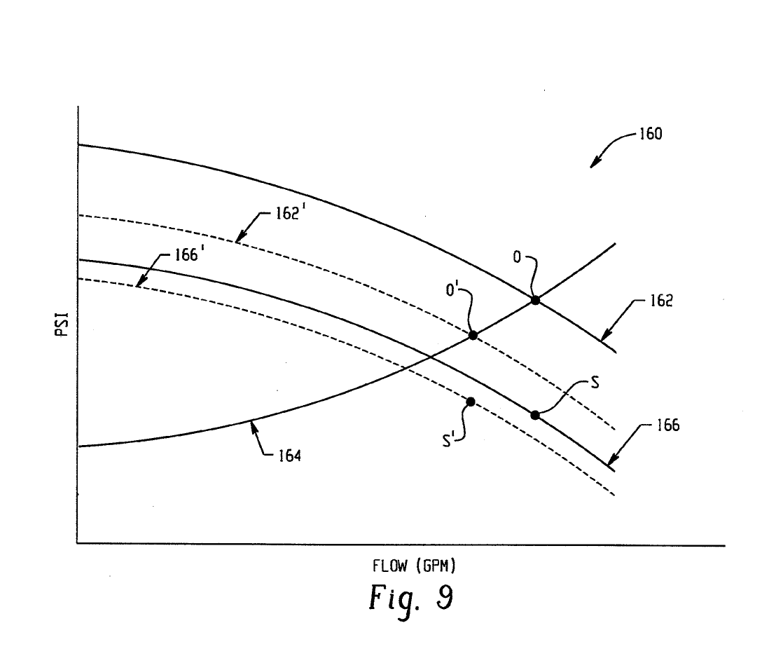

FIGS. 8 and 9 illustrate exemplary plots 154 and 160 of system and pump performance curves. This discussion of FIGS. 8 and 9 is for illustrative purposes and is not meant to be limiting. The pump performance curves 154 and 162 plot the pump's capacity versus pressure and is determined through tests conducted by the pump manufacturer. This typical pump performance curve 162 is plotted for a constant speed (RPM). The system resistance curve 164 plots the change in flow due to elevation considerations and frictional losses. The system resistance curve 164 is typically developed by the user (or other entity) based upon the conditions of service, such as physical layout, process conditions and fluid characteristics. The pumping system operates at point O where the pump performance curve 162 and the system resistance curve 164 intersect. A suction supply curve 166 plots the suction pressure versus change in flow. The suction supply curve 166 is often supplied by a municipality. The curves 162, 164 and 166 represent normal operating conditions. The operating suction pressure can be determined where a vertical line drawn through point O intersects the suction supply curve 166 at point S.

Referring first to FIG. 8, in some instances, the operating point O may force the suction pressure at point S below a specified limit 167. The throttle of engine 12 is decreased, which causes the pump performance curve 162 to move down (see dotted line 162′) As can be seen, moving the pump performance curve 162 down results in shifting the operating point to the left to point O′, thereby increasing the suction pressure higher along curve 166 (see point S′). The throttle is decreased until the operating point O′ is shifted to the left with a resulting shift in S′ that reaches the specified suction pressure limit 167.

In some instances, referring to FIG. 9, there may be a decrease in suction pressure, for example, due to sudden increased demand, which causes the suction supply curve 166 to move down (see dotted line 166′), thereby lowering the suction pressure at the operating point O. As described above, if the suction pressure decreases below the set pressure value (e.g., selected from a value between about 5 psi and about 30 psi), the throttle of the engine 12 is decreased, which causes the pump performance curve 162 to move down (see dotted line 162′). As can be seen, moving the pump performance curve 162 down results in shifting the operating point to the left to point O′, thereby maintaining or even increasing the suction pressure (see point S′).

The above-described engine throttle control systems are used to maintain a minimum suction pressure. Maintaining a minimum suction pressure can reduce or inhibit undesirable infiltration of ground water into the system, which can then enter the drinking water supply. Additionally, maintaining a minimum suction pressure can reduce or inhibit the effect of external forces on the pipes, which can potentially lead to pipe leakage or collapse. Additionally, the throttle control systems can shut down the engine if the suction pressure does not rise to or above the set pressure value despite a reduction in engine throttle.

It is to be clearly understood that the above description is intended by way of illustration and example only and is not intended to be taken by way of limitation, and that changes and modifications are possible. Accordingly, other embodiments are contemplated and modifications and changes could be made without departing from the scope of this application.

What is claimed is:

1. A building sprinkler system, comprising:
a pump that feeds a plurality of sprinkler heads;
a driver operatively connected to the pump for driving the pump; and
a speed control that is responsive to suction pressure at a suction side of the pump, the speed control configured to reduce driver speed when the suction pressure falls below a set threshold pressure value to maintain the suction pressure above the set threshold pressure value.

2. The building sprinkler system of claim 1 further comprising a building water source from which the pump receives water, the sprinkler system receiving water from the pump.

3. The building sprinkler system of claim 1 comprising:
a throttle for controlling driver speed; and
the speed control including an actuator including a throttle linkage connected to the throttle, the actuator lowering the throttle when the suction pressure falls below the set threshold pressure value.

4. The building sprinkler system of claim 3, wherein the actuator comprises a cylinder and a piston rod including a piston head located in the cylinder, the piston rod being connected to the throttle by the throttle linkage.

5. The building sprinkler system of claim 4 further comprising a valve assembly that receives fluid pressure from the suction side of the pump and fluid pressure from a discharge side of the pump, the valve providing fluid pressure to the actuator such that the actuator moves a throttle lever of the throttle when the suction pressure falls below the set threshold pressure value.

6. The building sprinkler system of claim 5, wherein the valve assembly comprises:
a pump discharge chamber connected to the discharge side of the pump;
a suction supply chamber connected to the suction side of the pump;
a control circuit chamber connected to the actuator for supplying fluid pressure to the cylinder; and
a fluid control member that controls flow of fluid from the pump discharge chamber to the control circuit chamber;
wherein the valve assembly is configured to prevent fluid from flowing into the control circuit chamber from the pump discharge chamber when pressure at the suction side of the pump is above the set threshold pressure value, the valve assembly configured to allow fluid to enter the control circuit chamber from the pump discharge chamber when pressure at the suction side of the pump falls below the set threshold pressure value.

7. The building sprinkler system of claim 1, wherein the speed control comprises:
a pressure sensor that senses pressure at the suction side of the pump; and
a throttle controller that receives a signal from the pressure sensor indicative of pressure at the suction side of the pump, the throttle controller configured to reduce driver speed when the suction pressure falls below the set threshold pressure value.

8. A method of controlling a pump driver of a building sprinkler system, the method comprising:
operating the pump driver connected to a pump thereby delivering fluid from a building fluid source; and
controlling speed of the pump driver based on pressure at a suction side of the pump.

9. The method of claim 8 further comprising reducing speed of the pump driver if pressure at the suction side of the pump falls below a set threshold pressure value.

10. The method of claim 9, wherein the set threshold pressure value is between about five and about 30 psi.

11. The method of claim 9 further comprising increasing the speed of the pump driver if pressure at the suction side of the pump increases above the set threshold temperature value.

12. The method of claim 9 further comprising shutting down the pump driver if a speed of the pump driver is below a minimum speed.

13. The method of claim 12 further comprising providing an indication to alert an operator when the pump driver is shut down.

14. A speed control system for controlling speed of a pump driver operatively connected to a pump of a building sprinkler system, the speed control system comprising:
a throttle for controlling pump driver speed; and
an actuator including a throttle linkage connected to the throttle, the actuator being controlled in response to pressure at a suction side of the pump, the actuator configured to move the throttle lever when the suction pressure falls below a set threshold pressure value.

15. The speed control system of claim 14, wherein the actuator comprises a cylinder and a piston rod including a piston head located in the cylinder, the piston rod being connected to the throttle by the throttle linkage.

16. The speed control system of claim 15 further comprising a valve assembly that receives fluid pressure from the suction side of the pump and fluid pressure from a discharge side of the pump, the valve providing fluid pressure to the actuator such that the actuator moves a throttle lever of the throttle when the suction pressure falls below the set threshold pressure value.

17. The speed control system of claim 16, wherein the valve assembly comprises:
a pump discharge chamber connected to the discharge side of the pump;
a suction supply chamber connected to the suction side of the pump;
a control circuit chamber connected to the actuator for supplying fluid pressure to the cylinder; and
a fluid control member that controls flow of fluid from the pump discharge chamber to the control circuit chamber;
wherein the valve assembly is configured to prevent fluid from flowing into the control circuit chamber from the pump discharge chamber when pressure at the suction side of the pump is above the set threshold pressure value, the valve assembly configured to allow fluid to enter the control circuit chamber from the pump discharge chamber when pressure at the suction side of the pump falls below the set threshold pressure value.

18. The speed control system of claim 14 comprising:
a pressure sensor that senses pressure at the suction side of the pump; and
a throttle controller that receives a signal from the pressure sensor indicative of pressure at the suction side of the pump, the throttle controller configured to change the throttle when the suction pressure falls below the set threshold pressure value.
